(19) United States
(12) Patent Application Publication
(10) Pub. No.: US 2007/0123221 A1
(43) Pub. Date: May 31, 2007

(54) Notification management

(76) Inventors: Frens Mazenier, Veenoord (NL); Johan Lundquist, Lund (SE)

Correspondence Address: HARRITY SNYDER, L.L.P., Suite 600, 11350 Random Hills Road, Fairfax, VA, 22030, US

(21) Appl. No.: 11/354,933

(22) Filed: Feb. 16, 2006

Related U.S. Application Data
(60) Provisional application No. 60/739,960, filed on Nov. 28, 2005.

(51) Int. Cl. H04Q 7/22

(52) U.S. Cl. 455/412.2

(57) ABSTRACT

A method and electronic apparatus is provided for managing at least one notification in an electronic apparatus. The method comprises generating the notification; and attaching to the notification at least one position attribute, which provides a geographical restriction for issuing the notification. The notification is issued when a geographical position if the electronic apparatus complies with the position attribute.

### RELATED APPLICATIONS

This application claims priority under 35 U.S.C. § 119 based on U.S. Provisional Application Ser. No. 60/739,960, filed Nov. 28, 2005, the disclosure of which is incorporated herein by reference.

### TECHNICAL FIELD OF THE INVENTION

The present invention relates to a method, and an electronic apparatus for managing notifications in the electronic apparatus.

### DESCRIPTION OF RELATED ART

An electronic apparatus, such as a mobile telephone, may comprise one or several functions for issuing notifications. A notification may e.g. be, or be associated with, an alarm, an alert, a calendar entry, a task entry, a note entry etc.

Normally, the notification is issued or notified at a predetermined or preset time and/or date. The notification may not be relevant at once when it is issued, or it is issued too late. For example, Peter had run out of bread. On his way home, Peter normally passes a bakery store. Peter usually leaves the office around 4 o'clock. Therefore, he set a task entry, as a notification with an alarm and a text message, to buy bread on his way home to be issued at 4 o'clock. Due to the fact that Peter left the office a little earlier than expected, the alarm was issued when he was already at home. As Peter had passed the bakery store on his way home, he had missed an opportunity to buy bread. Instead, he had to drive back to the bakery store to buy the bread.

As is apparent from the example, a notification that has a time/date attribute for its issuance may have the disadvantage to not be issued when actually desired. In the example given, the notification was issued too late. In other situations, the notification may be issued too early, whereby the user may have forgotten to do what he was reminded by the notification to do at the time when he may do it.

In other situations, a first person may want to have a meeting with a second person. To set up the meeting, the persons need to get in contact, e.g. by telephone or email, to determine a suitable time/date and place for the meeting. However, the meeting might not be all that important. Instead, the meeting may only be desirable if or when they are in relative proximity. However, to determine whether the participants of the meeting are in relative close proximity, they have to get in contact with each other. This is a relatively time consuming and inconvenient way to determine whether the condition for the meeting may be met.

Normally, calendars/note managers/task managers in the electronic apparatus only allows for time/date conditional notifications.

### SUMMARY OF THE INVENTION

According to a first embodiment, a method for managing at least one notification in an electronic apparatus, comprises generating the notification; and attaching to the notification at least one position attribute, which provides a geographical restriction for issuing the notification.

The method may comprise determining a geographical position; acquiring the position attribute; determining whether the geographical position complies with the position attribute; and issuing the notification associated with the position attribute if the geographical position complies with the position attribute.

The attaching may comprise attaching a position attribute, which comprises at least one geographical position, to the notification.

The attaching may comprise attaching a position attribute, which comprises an identifier for identifying an electronic device and a geographical constraint associated with the electronic device.

The attaching may comprise attaching a geographical constraint, which defines at least one of a distance, which defines a maximum distance between the electronic apparatus and the electronic device for allowing issuance of the notification, and a geographical position, at which the electronic device is to be located when the notification is issued.

The method may comprise submitting a request for periodical updates of the geographical position of the electronic device.

The acquiring may comprise receiving the geographical position of the electronic device. The determining may comprise determining whether the geographical position of the electronic device complies with the geographical constraint.

The generating may comprise generating a notification for at least one of an alarm, a calendar entry, a task entry, or an alert.

According to a second embodiment, an electronic apparatus operable to manage at least one notification, comprises a notification generation unit operable to generate the notification; and a processing unit operable to attach to the notification at least one position attribute, which provides a geographical restriction for issuing the notification.

The electronic apparatus may comprise a position determination unit operative to determine a geographical position; a matching unit operative to acquire the position attribute. The matching unit is operative to determine whether the determined geographical position complies with the position attribute. The processing unit is operative to issue the notification associated with the position attribute if the determined geographical position complies with the position attribute.

The processing unit may be operative to attach a position attribute, which comprises at least one geographical position, to the notification.

The processing unit may be operative to attach a position attribute, which comprises an identifier for identifying an electronic device and a geographical constraint associated with the electronic device.

The processing unit may be operative to attach a geographical constraint, which defines at least one of a distance, which defines a maximum distance between the electronic apparatus and the electronic device for allowing issuance of the notification, and a geographical position, at which the electronic device is to be located when the notification is issued.

The processing unit may be operative to submit a request for periodical updates of the geographical position of the electronic device.

The matching unit may be operable to receive the geographical position of the electronic device, and determine whether the geographical position of the electronic device complies with the geographical constraint.

The notification generation unit may be operable to generate a notification for at least one of an alarm, a calendar entry, a task entry, a note entry or an alert.

According to a third embodiment, a computer program product comprises computer program code means for executing the method when said computer program code means are run by an electronic device having computer capabilities.

According to a fourth embodiment, a computer readable medium has stored thereon a computer program product comprising computer program code means for executing the method, when said computer program code means are run by an electronic device having computer capabilities.

Further embodiments of the invention are defined in the dependent claims.

Some embodiments of the invention allow for a more flexible method and electronic apparatus for managing notifications.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Further objects, features and advantages of embodiments of the invention will appear from the following detailed description, reference being made to the accompanying drawings, in which:

FIG. 1 is a schematic view of an embodiment of the electronic apparatus and a communication system;

FIG. 2 is a block diagram of an embodiment of the electronic apparatus; and

FIG. 3 is a flow-chart of an the method for managing notifications.

### DETAILED DESCRIPTION OF EMBODIMENTS OF THE INVENTION

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

Embodiments of the invention provide methods and devices for managing notifications in an electronic apparatus 1. According to embodiments of the invention, a position attribute is attached to the notification. The position attribute provides a geographical restriction for issuing the notification. This allows for issuance of the notification in the electronic apparatus 1 if or when the position attribute is complied with. Thus, conditional issuance of the notification in dependence of a geographical position. The geographical position may be a geographical position of the electronic apparatus 1 or another electronic device. Embodiments of the invention thus allows for a more flexible setting of a conditional attribute for issuance of the notification compared to only having time/date conditional issuance, as the notification may be issued when it really is desired.

A notification according to embodiments of the invention may e.g. be or comprise an alarm, an alert, an acoustic signal, a text message, a tactile signal, an image or photo, a video sequence, a voice or video link with another party, e.g. in case of a desired meeting, etc.

A notification comprising a text message may e.g. be a calendar entry, a task entry, or a note entry.

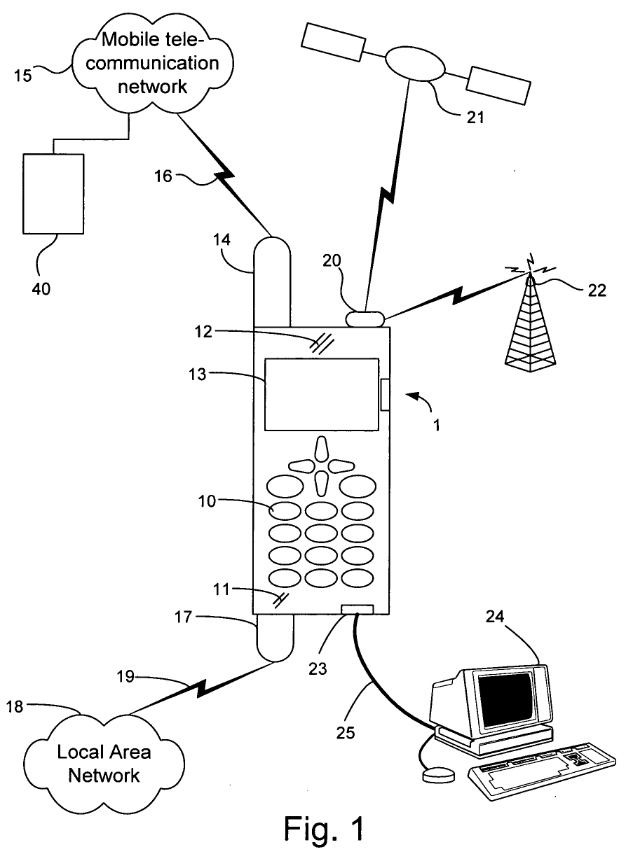

FIG. 1 illustrates the electronic apparatus 1 embodied as a mobile terminal. The invention is not limited to a mobile terminal, but can be incorporated into any electronic apparatus 1 having the possibility to issue a notification. The electronic apparatus 1 according to embodiments of the invention may comprise, but is not limited to, a portable or handheld electronic apparatus, a mobile radio terminal, a mobile telephone, a pager, a personal digital assistant (PDA), a communicator, a smartphone, or an electronic organizer.

In the embodiment of FIG. 1, the electronic apparatus 1 comprises a man-machine or user interface (UI) comprising, but not limited to, a keypad 10, a microphone 11, a loudspeaker 12 and a display 13. The UI may also comprise a camera (not shown). The UI may be used for operating and interacting with the electronic apparatus 1, such as generating the notification by means of the keypad 10, and issuing the notification in or by means of the display 13 and/or the loudspeaker 12.

The electronic apparatus 1 may optionally comprise various communication means for communicating with other electronic equipment. A first antenna 14 is adapted for communication with e.g. a mobile telecommunication network 15 over a first wireless link 16. The telecommunication network 15 may e.g. be a GSM (General System for Mobile communication), a UMTS (Universal Mobile Telecommunications System), a PDC (Personal Digital Cellular system), a IS-136, a IS-95, a IMT-2000 (International Mobile Telecommunications 2000) or any other communication network.

A second antenna 17 is adapted for short-range supplementary communication with a local area network 18 or a peripheral electronic device over a second wireless link 19. The second wireless link 19 may e.g. be a Bluetooth® link.

A third antenna or reception means 20 is adapted to receive position and time data from several satellites 21 (only one is shown) or pseudolites 22 (only one is shown). The electronic apparatus 1 is adapted to determine the geographical position of the electronic apparatus 1 on the surface of the earth. The geographical position may be determined based on information received from the satellite 21 and/or pseudolite 22.

With pseudolite is meant a position data transmitting means, which is located on the ground and which transmits data similar to position and time data transmitted from a satellite 21.

An accessory connector 23 may be provided for connecting the electronic apparatus 1 to various peripheral devices. A computer 24 having input means, such as a keyboard and a mouse, may be connected to the accessory connector 23 by means of a cable 25, such as a serial cable. Alternatively, the computer 24 is connected to the mobile terminal 1 by means of a wireless link, such as the second link 19. The notification may e.g. be entered by means of the computer 24, e.g. by synchronizing a calendar stored in the electronic apparatus 1 and a calendar stored in the computer 24.

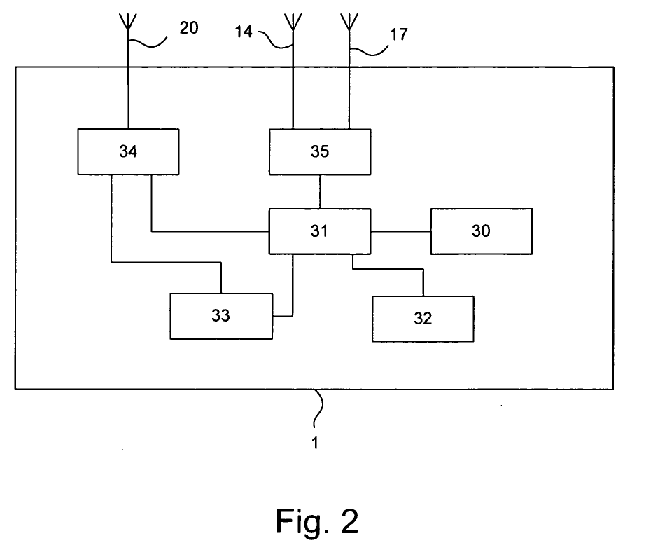

FIG. 2 illustrates an embodiment of some components of the electronic apparatus 1. The illustrated embodiment of the electronic apparatus 1 comprises a notification generation unit 30, a processing unit 31, a memory 32, a matching unit 33, a position determination unit 34, and a communication unit 35. In some embodiments of the invention, no communication unit is needed for managing the notifications.

The notification generation unit 30 may comprise the UI for generating the notification within the electronic apparatus 1. The notification may e.g. be generated by generating an entry in calendar, a note manager, and/or a task manager. The notification may be generated by inputting text to be issued in the future. The notification may also/or alternatively be generated by setting an alarm or alert. The note may e.g. be text message comprising e.g. a reminder to do and/or buy a certain thing, meet a certain person, etc.

The notification generation unit 30 may in some embodiments comprise a synchronization engine. Thus, a notification may be generated in the electronic apparatus 1 by receiving notifications from an electronic device, with which the electronic apparatus 1 is synchronized.

The processing unit 31 is adapted to attach the position attribute to the notification. The position attribute may be set by means of the UI. The position attribute may be attached to the notification by storing them together in the memory 32. The position attribute may e.g. be included in a certain portion of a file. The certain portion may e.g. be a header of the file containing the notification. Alternatively, the notification and the attached position attribute are stored in a table. The notification and attached position attribute may be stored in different columns but on the same row.

The processing unit 31 is connected to the memory 32. The memory 32 may comprise one or several storing means for temporarily and permanent storage of data and software instructions. The memory 32 may e.g. comprise a random access memory, a read only memory, and/or a flash memory. Geographical data, notifications and position attributes may be stored in the memory 32.

The communication unit 35 may provide wireless communication capabilities for communicating with the mobile telecommunication network 15 and the local area network 18 according to any of the above-mentioned technologies. Data comprising the geographical position of an electronic device 40 operatively connected to the mobile telecommunication network 15 may be received via the communication unit 35. The geographical position of the electronic device 40 may e.g. be periodically uploaded to a server (not shown) connected to the mobile telecommunication network 15. Thus, updates of the geographical position of the electronic device may be received from the server in the electronic apparatus 1.

The position determination unit 34 is connected to the third antenna 20. The position determination unit 34 is adapted to determine the geographical position of the mobile terminal 1. The geographical position may be determined based on received position data. In one embodiment, the position determination unit 34 comprises a GPS receiver. The GPS receiver may determine the geographical position of the electronic apparatus 1 based on data received from the satellites 21 and/or from the pseudolites 22. A GPS unit allows for relatively accurate position determinations.

Alternatively, the position determination unit 34 uses another position determination system, such as a network based positioning system, which may be collocated or consolidated with the base stations of the mobile telecommunication network 15. The network based positioning system may determine the geographical position of the mobile terminal 1 e.g. based on received signal measurements. The measurements may comprise angle of arrival, time difference and signal strength of received signals. Once the geographical position of the electronic apparatus 1 is determined, it may be reported back to the electronic apparatus 1.

It is also possible to determine the position of the electronic apparatus 1 in a GSM telecommunication system. The electronic apparatus 1 may receive timing data from three different base stations. Based on the arrival time of the data received from the base stations, the geographical position of the electronic apparatus 1 may be determined. One such system is the E-OTD (Enhanced Observed Time Difference).

The matching unit 33 is adapted to determine whether a determined geographical position complies with or matches a certain position attribute attached to a notification. The determined geographical position may be the geographical position of the electronic apparatus 1 currently is at. Alternatively, the determined geographical position is the geographical position, at which the electronic apparatus 1 was positioned when the last determination of the geographical position of was determined. Still alternatively, the determined geographical position may be a position of the electronic device.

A position attribute may e.g. comprise at least one geographical position, such as geographical coordinates (latitude, longitude). The geographical position may be a position at which the notification should be issued.

The geographical position of the position attribute may e.g. be attached to the notification in response to determining the current position of the electronic apparatus 1. The current position may e.g. be determined in response to the user pushes a certain key. Then, the position attribute may be automatically attached to a generated notification.

In one embodiment, the position attribute is selectable from at least one predetermined geographical position. The predetermined geographical position may e.g. be entered by the user. The electronic apparatus 1 may e.g. comprise the capability “add geographical position”. When a certain key is activated, the current position of the electronic apparatus 1 is added to the predetermined geographical positions. This allows for adding “favorite” geographical positions, such as at a store, a friend's home, an office etc.

The coordinates of the geographical position may alternatively be manually entered, e.g. by means of the UI.

In some embodiments, the position attribute is generated from a map displayed on the display 13. A cursor may e.g. be moveable over the map, e.g. by means of a joystick, a stylus, or a pointer. When a key is pressed, the geographical position indicated by the cursor will provide the position attribute. Alternatively, the stylus or pointer is pressed against the display, if it is a touch sensitive display, at the position wherein the geographical position should be generated. When the geographical position is chosen from the map, a circle may be generated around the geographical position. The radius of the circle may equal the displacement of the stylus. The circle may indicate a geographical area, which the electronic apparatus 1 should be positioned in to comply with the position attribute. Thus, the geographical area may be defined by a plurality of geographical positions. Of course, the geographical area may be generated in other ways, such as manually entering a plurality of geographical positions.

In some embodiments, a position attribute, which comprises an identifier for identifying the electronic device 40 and a geographical constraint to be complied with by said electronic device 40, may be attached to the notification.

The identifier may e.g. be a telephone number, SIM (Subscriber Identity Module) number, or IMEI (International Mobile Equipment Identifier) number.

The position attribute may be a condition that the electronic apparatus 1 and the electronic device 40 should be located in relative close proximity in order for determined geographical position to comply with the position attribute. Relative proximity may be a predetermined or preset distance. The distance may also be user defined.

The geographical constraint may e.g. be a certain distance or a certain geographical area.

To comply with the position attribute, the geographical constraint should be complied with. This allows for conditional issuing of the notification in dependence of whether the electronic apparatus 1 is within a certain distance from the electronic device 40, and/or in dependence of whether the electronic apparatus 1 and the electronic device 40 is located in the same geographical area. The geographical constraint, may also define a geographical position, at which the electronic device 40 is to be located when the notification is to be issued. The geographical position of the electronic device 40 is useable for determining whether the determined geographical position complies with the geographical constraint.

The position attribute may be acquired by the matching unit 33. The position attribute may be acquired from the memory 32. The matching unit 33 may e.g. periodically determine whether any position attribute stored in a look-up table match the current geographical position of the electronic apparatus 1.

Acquiring the position attribute may comprise receiving a geographical position. For example, the position of the electronic device 40 may e.g. be acquired from the mobile telecommunication network 15. To receive the geographical position of the electronic device 40, a request for periodical updates of the geographical position of the electronic device 40 may be submitted, e.g. to an operator or server of the mobile telecommunication network 15. The request may e.g. be submitted by the processing unit 31 and transmitted by the communication unit 35. The geographical position of the electronic device 40 may ultimately be received by the matching unit 33. When it has been received the matching unit 33 may determine whether the geographical position of the electronic device 40 complies with the geographical constraint, and thus with the position attribute.

If the geographical position of the electronic apparatus 1 matches any position attribute, the processing unit 31 may be notified accordingly. Then, the processing unit 31 may issued the notification having attached the position attribute, which matched the geographical position of the electronic apparatus 1. Issuing the notification may comprise displaying a text message in the display 13, rendering an alarm etc.

The matching unit 33, the processing unit, and/or at least parts of the notification generation unit 30 may be implemented by one or several processors, ASICs (Application Specific Integrated Circuits), and/or FPGAs (Field Programmable Gate Array). The processor(s) may provide the functions of the units by running computer readable instructions provided therefore.

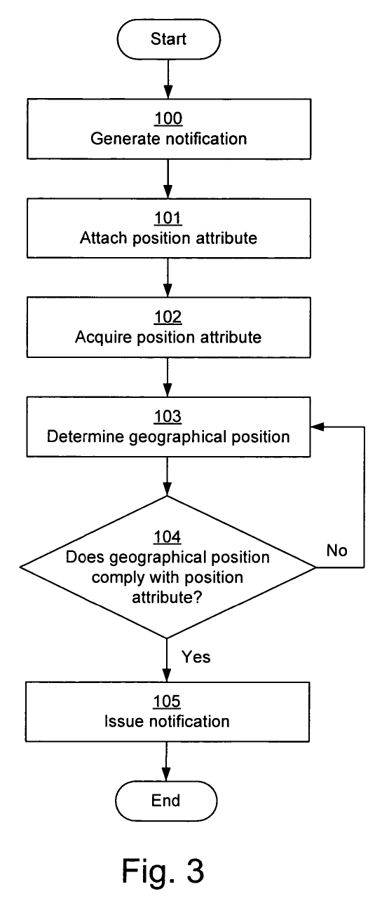

FIG. 3 illustrates an embodiment of a method for managing notifications. In a first step 100, the notification is generated. The notification may be generated as described above, e.g. by entering a calendar entry, a task entry, a note entry, synchronizing calendars, etc. In step 101, the position attribute is attached to the notification. The notification may be attached by first selecting or generating the position attribute, which then may be stored, possibly together with the notification. Attaching the position attribute may also comprise attaching a position attribute comprising the identifier for identifying the electronic device 40. The position attribute may also comprise the geographical constraint of the electronic apparatus 1 and/or the electronic device 40. In step 102, the position attribute is acquired. The position attribute may be acquired from the memory 32, in which it may be stored. In step 103, a geographical position is determined. The determined geographical position may be a geographical position, at which the electronic apparatus 1 currently is located. Alternatively, the determined geographical position is the geographical position, at which the electronic device 40 currently is located and which may be received from the server. The identifier of the electronic device 40 may also be received together with the received geographical position. Thus, the received geographical position may be identified as the geographical position of the electronic device 40. In step 104, it is determined whether the determined geographical position complies with the position attribute. The compliance may be determined by determining whether the determined geographical position corresponds to a geographical position of the position attribute. Alternatively, the determined geographical position may correspond to one of a plurality of geographical positions of a position attribute. Still alternatively, the distance between the determined geographical position, which may be either of the position of the electronic apparatus 1 or the electronic device 40, and the other of the electronic apparatus 1 and the electronic device 40 may be determined. Thus, if the position attribute is a distance, it may be determined whether the determined distance complies with the distance of the position attribute. Thus, it is inherently determined whether the determined geographical position complies with the position attribute. Still an alternative is to determine whether the determined geographical position is within a certain geographical area, which is comprised in the position attribute. If the answer in step 105 is yes, the notification is issued in step 106. If the answer in step 105 is no, the procedure returns to step 103. Alternatively, the procedure is ended if the answer is no in step 105. Also, the procedure may return to step 103 even if the answer in step 105 is yes, such as if a look-up table for storing position attributes contains further positions attributes.

Some embodiments of the invention allows for increased flexibility of the electronic apparatus 1, as it is possible to attach position attributes to the notification. The position attribute is more flexible than a time attribute, which is not a conditional attribute. This allows for issuing of the notifications at a moment when it is really desired rather than at a preset time. Furthermore, some embodiments of the invention allows for reduced communication in the network. If a notification is set to be issued when the electronic apparatus 1 relatively close to the electronic device 40, the user of the electronic apparatus 1 may chose to only contact the user of the electronic device 40 when the notification is issued. Thus, attempts to contact the user of the electronic device 40 may be avoided.

According to the above, each position attribute has been described as been associated with a single notification. However, each position attribute may be associated with a plurality of notifications. Thus, a single position attribute may be attached to a plurality of notifications. The plurality of notifications may be unrelated. Thus, a single position attribute is associated with at least one notification. This allows for a decreased number of position attributes that have to be traversed each time it is to be determined whether any position attribute complies with a determined geographical position. Thus, a position attribute may be attached to a notification, or vice versa.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the present invention may be embodied as a mobile terminal, method or computer program product. Accordingly, the present invention may take the form of an entirely hardware embodiment, a software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Exemplary embodiments of the present invention are described herein with reference to flowchart and/or block diagrams. It will be understood that some or all of the illustrated blocks may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

A computer program product may comprise computer program code means for executing the method, as described in the description and the claims, for managing at least one notification when said computer program code means are run by an electronic device having computer capabilities.

A computer readable medium having stored thereon a computer program product may comprise computer program code means for executing the method, as described in the description and the claims, for managing at least one notification when said computer program code means are run by an electronic device having computer capabilities.

It is to be understood that the functions/acts noted in the diagrams may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

The present invention has been described above with reference to specific embodiments. However, other embodiments than the above described are equally possible within the scope of the invention. The different features and steps of the invention may be combined in other combinations than those described. The scope of the invention is only limited by the appended patent claims.

What is claimed is:

1. A method for managing at least one notification in an electronic apparatus, comprising:
generating the notification; and
attaching to the notification at least one position attribute, which provides a geographical restriction for issuing the notification.

2. The method according to claim 1, comprising
determining a geographical position;
acquiring the position attribute;
determining whether the geographical position complies with the position attribute; and
issuing the notification associated with the position attribute if the geographical position complies with the position attribute.

3. The method according to claim 1, wherein said attaching comprises attaching a position attribute, which comprises at least one geographical position, to the notification.

4. The method according to claim 2, wherein said attaching comprises attaching a position attribute, which comprises an identifier for identifying an electronic device and a geographical constraint associated with the electronic device.

5. The method according to claim 4, wherein said attaching comprises attaching a geographical constraint, which defines at least one of a distance, which defines a maximum distance between the electronic apparatus and the electronic device for allowing issuance of the notification, and a geographical position, at which the electronic device is to be located when the notification is issued.

6. The method according to claim 4, comprising submitting a request for periodical updates of the geographical position of the electronic device.

7. The method according to claim 4, wherein said acquiring comprises receiving the geographical position of the electronic device; and
said determining comprises determining whether the geographical position of the electronic device complies with the geographical constraint.

8. The method according to claim 1, wherein said generating comprises generating a notification for at least one of an alarm, a calendar entry, a task entry, or an alert.

9. An electronic apparatus operable to manage at least one notification, comprising:
a notification generation unit operable to generate the notification; and
a processing unit operable to attach to the notification at least one position attribute, which provides a geographical restriction for issuing the notification.

10. The electronic apparatus according to claim 9, comprising:
a position determination unit operative to determine a geographical position; and
a matching unit operative to acquire the position attribute; wherein
the matching unit is operative to determine whether the determined geographical position complies with the position attribute; and
the processing unit is operative to issue the notification associated with the position attribute if the determined geographical position complies with the position attribute.

11. The electronic apparatus according to claim 9, wherein the processing unit is operative to attach a position attribute, which comprises at least one geographical position, to the notification.

12. The electronic apparatus according to claim 9, wherein the processing unit is operative to attach a position attribute, which comprises an identifier for identifying an electronic device and a geographical constraint associated with the electronic device.

13. The electronic apparatus according to claim 12, wherein the processing unit is operative to attach a geographical constraint, which defines at least one of a distance, which defines a maximum distance between the electronic apparatus and the electronic device for allowing issuance of the notification, and a geographical position, at which the electronic device is to be located when the notification is issued.

14. The electronic apparatus according to claim 12, wherein the processing unit is operative to submit a request for periodical updates of the geographical position of the electronic device.

15. The electronic apparatus according to claim 12, wherein the matching unit is operable to receive the geographical position of the electronic device, and determine whether the geographical position of the electronic device complies with the geographical constraint.

16. The electronic apparatus according to claim 9, wherein said the notification generation unit is operable to generate a notification for at least one of an alarm, a calendar entry, a task entry, a note entry or an alert.

17. A computer program product comprising computer program code means for executing the method according to claim 1, when said computer program code means are run by an electronic device having computer capabilities.

18. A computer readable medium having stored thereon a computer program product comprising computer program code means for executing the method according to claim 1, when said computer program code means are run by an electronic device having computer capabilities.
